(19) United States
(12) Patent Application Publication
(10) Pub. No.: US 2026/0326159 A1
(43) Pub. Date: Oct. 22, 2026

(54) Pressure washer and method for operating a pressure washer

(71) Applicant: Andreas Stihl AG & Co. KG, Waiblingen (DE)

(72) Inventor: Fabian Broghammer, Rudersberg (DE)

(73) Assignee: Andreas Stihl AG & Co. KG, Waiblingen (DE)

(21) Appl. No.: 19/648,847

(22) Filed: Apr. 15, 2026

(30) Foreign Application Priority Data
Apr. 17, 2025 (DE) 102025115220.9

(51) Int. Cl. B08B 3/02

(52) U.S. Cl. CPC B08B 3/026; B08B 2203/0205

(57) ABSTRACT

A pressure washer includes a high-pressure pump for conveying liquid in a conveying direction and a main line, through which liquid can be conveyed by means of the high-pressure pump. The main line has a suction chamber upstream of the high-pressure pump and a pressure chamber downstream of the high-pressure pump, between which a return line for fluid connection is arranged. The pressure washer includes a start valve for preventing liquid from flowing through the return line, and a check valve arranged in the pressure chamber downstream of the return line. The pressure washer includes an additional valve formed separately from the start valve for interrupting the fluid connection between the pressure chamber and the suction chamber through the return line, which is biased toward a closed state. The pressure washer is configured such that the check valve opens at a lower pressure than the additional valve.

### CROSS-REFERENCE TO RELATED APPLICATION

This application claims the benefit of German Patent Application DE 102025115220.9, filed Apr. 17, 2025, the contents of which is incorporated by reference in its entirety.

### TECHNICAL FIELD

The disclosure relates to a pressure washer and a method for operating a pressure washer.

### BACKGROUND

The use of a start valve in a pressure washer is described in EP 4 480 592 A1. For a simplified start-up of the high-pressure pump or the motor for driving the high-pressure pump, a return line is provided, in which the start valve is arranged. The pressure washer is configured such that the start valve closes in such a way that no liquid can flow from the pressure chamber into the suction chamber through the return line when the volume flow through the start valve corresponds at least to a start volume threshold value. However, it is possible for liquid to flow through the return line below this start volume threshold value. This facilitates the start-up of the high-pressure pump or the motor of the high-pressure pump. The high-pressure pump then does not have to work against a high pressure in the pressure chamber in particular when the main line valve is closed. In the start-up phase, the high-pressure pump can circulate liquid via the return line from the pressure chamber into the suction chamber without having to work against a high counterpressure with initially low torque. In this way, until the start volume threshold value is reached and the start valve closes, the pump can reach a rotational frequency at which it can provide a sufficient torque in the case of corresponding counterpressure. Only once the high-pressure pump or the motor has reached this rotational frequency does it have to work against a higher pressure in the pressure chamber. In pressure washers from the prior art, it can be the case that the start volume threshold value is not reached, despite a long start-up phase for the high-pressure pump or the motor of the high-pressure pump. This can be the case even though the motor of the high-pressure pump has already reached its operating speed.

### SUMMARY

An object of the disclosure is to improve a generic pressure washer in such a way that the desired operating conditions of a pressure washer having a start valve are achieved quickly and reliably. This is achieved by a pressure washer as disclosed and claimed.

A further object of the disclosure is to improve a generic method for operating a pressure washer having a start valve in such a way that the desired operating conditions of the pressure washer are achieved quickly and reliably. This object is achieved by a method as disclosed and claimed.

The high-pressure pump of a pressure washer is often filled with air during the start-up or after a dry run of the high-pressure pump. The disclosure is based on the recognition that this can lead to the valves of the pressure washer, in particular the pressure differential valves, having unintentional switching behaviour. With regard to the start valve, this can lead to the start valve not closing. The required start volume threshold value is never reached because air is inadvertently circulated through the return lines. In order to prevent this, an additional valve is provided for interrupting the fluid connection between the pressure chamber and the suction chamber which is possible due to the return line. The additional valve is, in a closed state, biased in a direction opposite the conveying direction of the liquid in the pressure washer. The conveying direction is in particular predetermined by the line system of the pressure washer. The conveying direction is the direction in which a fluid, in particular a liquid, flows due to the line routing and due to the effect of the high-pressure pump. The conveying direction can point in different directions in different partial lines of the line system. The pressure washer comprises a check valve which is arranged in the pressure chamber downstream of the return line. The check valve serves to prevent liquid from flowing against the conveying direction. The check valve is biased toward a closed state in a direction opposite the conveying direction. The pressure washer is configured in such a way that the check valve opens at a lower pressure, in particular at a lower differential pressure, than the additional valve. In particular, the check valve opening pressure required to open the check valve is lower than the additional valve opening pressure required to open the additional valve. In particular, an additional valve pressure difference between the region upstream of the additional valve and the region downstream of the additional valve, in particular in the return line, is required to open the additional valve. In particular, a check valve pressure difference between the region upstream of the check valve and the region downstream of the check valve, in particular in the pressure chamber, is required to open the check valve. In particular, the check valve pressure difference is smaller than the additional valve pressure difference. Due to the fact that the check valve opens at a lower pressure than the additional valve, when the high-pressure pump or the motor for driving the high-pressure pump starts up, the check valve is opened by any air found in the high-pressure pump, while the additional valve is still closed. This prevents air from being circulated through the return line and through the additional valve. The air escapes from the pressure washer through the check valve through the main line. Afterwards, the high-pressure pump conveys liquid. The pressure generated by the liquid then suffices to open the additional valve. In this way, as has also been provided in the prior art, liquid can be circulated via the return line during a start-up phase. The high-pressure pump or the motor for driving the high-pressure pump does not have to work against an excessive pressure. Only when the high-pressure pump, in particular the motor for driving the high-pressure pump, has reached a corresponding speed and thereby the volume flow has reached the start volume threshold value, the start valve closes and the start phase of the pressure washer is completed. In this way, the desired operating conditions of the pressure washer can be achieved quickly and reliably. An inadvertent circulation of air is thereby safely and reliably avoided.

The check valve is biased with a return restoring force into the closed state of the check valve. The additional valve is biased with an additional valve force into the closed state of the additional valve. A fluid, in particular the liquid and/or air, can act on the check valve with a, in particular hydraulically effective, return cross-sectional area. A fluid, in particular the liquid and/or air, can act on the additional valve with a, in particular hydraulically effective, additional valve cross-sectional area. In particular, the return restoring force, the return cross-sectional area, the additional valve force and the additional valve cross-sectional area are coordinated with each other in such a way that the check valve opens at a lower pressure, in particular at a lower differential pressure, in particular at a lower opening pressure, than the additional valve. In particular, the return restoring force, the return cross-sectional area, the additional valve force and the additional valve cross-sectional area are coordinated with each other in such a way that the check valve pressure difference is smaller than the additional valve pressure difference. This easily enables the check valve to open at a lower pressure than the additional valve.

In particular, the additional valve force is greater than the return restoring force. In particular, the additional valve cross-sectional area is smaller than the return cross-sectional area. This easily enables the check valve to open at a lower pressure than the additional valve.

In particular, the check valve has a return spring. The return spring provides the return restoring force. In particular, it is alternatively or additionally provided that the additional valve has an additional valve spring. The additional valve spring provides the additional valve force.

The start valve has a start valve member. In particular, the start valve member is formed separately from an additional valve member of the additional valve. In this way, the start valve and the additional valve can easily be arranged in different places in the pressure washer. In particular, the start valve can be arranged in the main line. In particular, the additional valve can simultaneously be arranged in the return line.

In particular, the start valve is arranged in the main line downstream of the high-pressure pump. In this way, the complete, undivided volume flow of liquid comes into contact with the start valve. Since no portion of the volume flow has been branched off out of the main line before the volume flow comes into contact with the start valve, the start valve closes and opens reliably. The parameter that determines whether the start valve opens or closes is reliably reproducible. Since the volume flow coming into contact with the start valve is undivided, external parameters that have an influence on how large the branched-off portion of the volume flow into the return line is do not play any role. In particular, the volume flow at the start valve is independent of the nozzle cross-section of a nozzle used at the spray opening. Therefore, the points in time, or the speeds of the motor, at which the start valve opens and closes, are reproducible. This results in the pressure against which the high-pressure pump has to work during the start-up also being reproducible. Due to the arrangement of the start valve in the main line, the start valve can work reliably and reproducibly. Accordingly, the start valve reliably only closes when the motor has reached a speed in its operating speed range during start-up.

In particular, the start valve member is arranged completely in the main line, in particular in the pressure chamber. In particular, the start valve member is arranged completely outside the return line. In particular, a start valve seat of the start valve is formed at an inlet of the return line. This easily ensures that the complete, undivided volume flow of liquid comes into contact with the start valve before a portion of the volume flow has been branched off out of the main line.

In particular, the additional valve is arranged in the return line. This easily enables the interruption of the fluid connection between the pressure chamber and the suction chamber through the return line.

In particular, the additional valve is arranged downstream of the start valve. In this way, it is easily possible to arrange the start valve in the main line.

To close the start valve, a start pressure difference between the region upstream of the start valve and the region downstream of the start valve, in particular the region in the return line downstream of the start valve, is necessary. In particular, the additional valve pressure difference is smaller than the start pressure difference. In particular, the pressure washer is configured such that, during the start-up phase of the high-pressure pump, in particular of the motor for driving the high-pressure pump, the additional valve opens before the start valve closes. It is thus easily ensured that during the start-up phase of the pressure washer, the high-pressure pump, in particular the motor, can circulate liquid via the return line and does not have to work against the high pressure in the pressure chamber, in particular in the region in front of the spray opening. In particular, the start valve closes when the volume flow of the liquid in the pressure chamber exceeds a start volume flow threshold value. In particular, the additional valve opens when the pressure at the additional valve exceeds an opening pressure threshold value. The opening pressure threshold value is exceeded when the volume flow of the liquid in the pressure chamber exceeds an opening volume flow threshold value. In particular, the start volume flow threshold value is greater than the opening volume flow threshold value. It is thus easily effected that the additional valve opens in the start-up phase before the start valve closes.

According to the method for operating a pressure washer, it is provided that the pressure washer comprises an additional valve, formed separately from the start valve, for interrupting the fluid connection between the pressure chamber and the suction chamber through the return line. The additional valve is biased in a closed state in the direction opposite the conveying direction. The pressure washer comprises a check valve arranged in the pressure chamber downstream of the return line. The check valve serves to prevent liquid flowing in the direction opposite to the conveying direction. The check valve is biased in a closed state in the direction opposite to the conveying direction. According to the method, it is provided that the check valve is opened at a lower pressure than the additional valve. This is associated with the advantages described for the pressure washer.

The method can be developed around the optional features of the pressure washer which are described above. This is associated with the respective advantages correspondingly mentioned above.

Exemplary embodiments of the invention are explained below using the drawing.

### BRIEF DESCRIPTION OF THE DRAWINGS

FIG. 1 shows a schematic depiction of a pressure washer having a start valve in the main line in an operating state, in which the high-pressure pump does not convey any liquid and the return line is not closed by the start valve but by the additional valve.

FIG. 2 shows a schematic depiction of the pressure washer from FIG. 1 in an operating state, in which the high-pressure pump conveys air through the opened check valve in the main line to the spray opening, while the start valve is opened and the additional valve is closed.

FIG. 3 shows a schematic depiction of the pressure washer from FIG. 1 in an operating state, in which the high-pressure pump conveys liquid in such a way that the volume flow of the liquid conveyed through the start valve lies below the start volume threshold value, but the pressure of the liquid in the return line suffices to open the additional valve.

FIG. 4 shows a schematic depiction of the pressure washer from FIG. 1 in an operating state, in which the high-pressure pump conveys liquid with a volume flow through the start valve above the start volume threshold value, such that the start valve closes the return line and the additional valve is closed.

FIG. 5 shows a schematic depiction of a pressure washer in an alternative embodiment having a start valve in the return line in an operating state, in which the high-pressure pump conveys liquid with a volume flow through the start valve above the start volume threshold value, such that the start valve closes the return line and the additional valve is closed.

### DETAILED DESCRIPTION

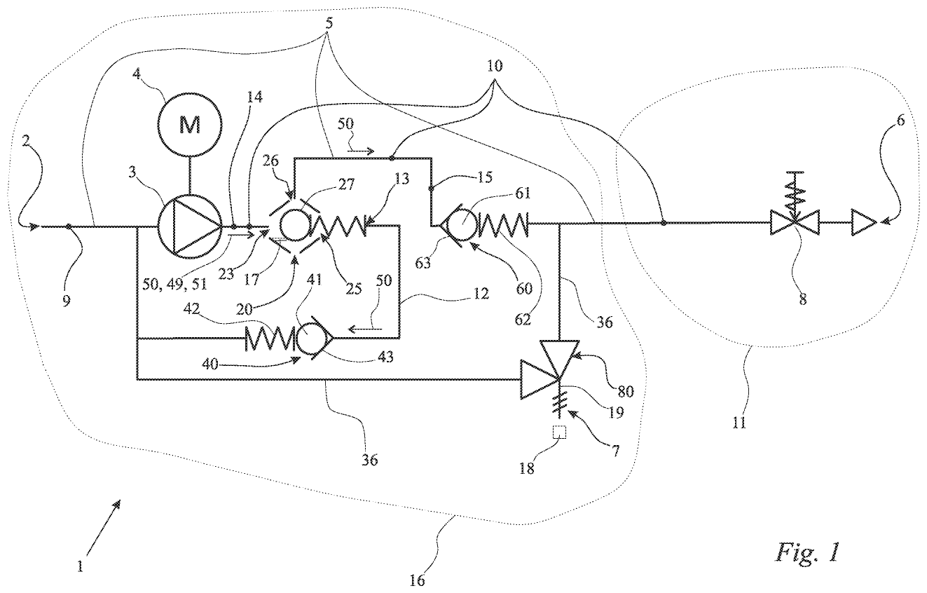

FIG. 1 shows, in a schematic depiction, a pressure washer 1. The pressure washer 1 comprises a pump unit 16 and a spray unit 11. The pump unit 16 and the spray unit 11 are fluidically connected to each other via a main line 5. In the exemplary embodiment, the spray unit 11 comprises a gun, not depicted. It can, however, also be provided that the spray unit comprises a gun and a lance.

The pressure washer 1 comprises a port 2 for connection to a liquid source. In the exemplary embodiment, the liquid source is an external liquid source. The external liquid source can be, for example, a domestic water supply system. However, it can also be provided that the liquid source is an integral component of the pressure washer.

The pressure washer 1 comprises a spray opening 6. The pressure washer 1 comprises the main line 5. The main line 5 of the pressure washer 1 fluidically connects the port 2 to the spray opening 6. The port 2 is arranged on the pump unit 16. The spray opening 6 is arranged on the spray unit 11. In the exemplary embodiment, the spray opening 6 is arranged on the spray unit 11 formed as a gun. However, it can also be provided that the spray opening 6 is arranged on an, in particular replaceable, lance of the spray unit 11.

The pressure washer 1 comprises a high-pressure pump 3. The high-pressure pump 3 is a component of the pump unit 16. By means of the high-pressure pump 3, liquid can be pressurised in the pressure washer 1, in particular in the pump unit 16. The liquid is in particular water, in particular a mixture of water and an additive. The additive is in particular a cleaning solution, in particular a soap solution. In particular, the cleaning agent is liquid. By means of the high-pressure pump 3, the liquid can be pressurised by at least 10 bar, in particular at least 15 bar, in particular at least 30 bar, in particular at least 100 bar. In particular, the liquid can be pressurised by the high-pressure pump 3 with a pressure of a maximum of 600 bar, in particular a maximum of 500 bar. The high-pressure pump 3 comprises at least one piston, which is not depicted. The at least one piston can be moved back and forth to exert pressure on the liquid. Typically, the high-pressure pump 3 comprises three pistons.

Liquid can be conveyed from the port 2 to the spray opening 6 through the main line 5 by means of the high-pressure pump 3, in particular in a conveying direction 50. The conveying direction 50 is predetermined by the line system of the pressure washer 1. The conveying direction 50 is the direction in which a fluid, in particular the liquid, flows due to the line guidance and due to the effect of the high-pressure pump 3. The conveying direction 50 can point in different directions in different partial lines of the line system.

The liquid source supplies liquid to the main line 5. The high-pressure pump 3 is arranged in the main line 5. The main line 5 has a suction chamber 9 and a pressure chamber 10. The high-pressure pump 3 is arranged between the suction chamber 9 and the pressure chamber 10 of the main line 5. The main line 5 has the suction chamber 9 between the port 2 and the high-pressure pump 3. The main line 5 has the pressure chamber 10 between the high-pressure pump 3 and the spray opening 6. In the exemplary embodiments, the suction chamber 9 is formed by a section of the main line 5 between the port 2 and the high-pressure pump 3. In the exemplary embodiments, the pressure chamber 10 is formed by a section of the main line 5 between the high-pressure pump 3 and the spray opening 6. The high-pressure pump 3 conveys liquid from the suction chamber 9 to the pressure chamber 10. In the pressure chamber 10, there is a higher pressure when the high-pressure pump 3 is in operation than in the suction chamber 9. The suction chamber 9 and the pressure chamber 10 are components of the main line 5. There is a higher pressure in the main line 5 downstream of the high-pressure pump 3 than upstream of the high-pressure pump 3. In the suction chamber 9, the conveying direction 50 runs from the port 2 to the high-pressure pump 3. In the pressure chamber 10, the conveying direction 50 runs from the high-pressure pump 3 to the spray opening 6.

The high-pressure pump 3 is arranged in the pump unit 16. To drive the high-pressure pump 3, the pressure washer 1 has a motor 4. The motor 4 is arranged in the pump unit 16. The motor 4 can be formed as a brushless DC motor. A brushless DC motor is also referred to as an EC motor. The motor 4 can also be a universal motor. In the exemplary embodiment, the motor 4 is an induction motor. The induction motor in the exemplary embodiment is operated with alternating current. The voltage source can, for example, be made available by the mains voltage. If battery operation is provided, the motor can also be a brushless DC motor. It can then be provided that the battery is a component of the pressure washer 1. In particular, it can then be provided that the pump unit 16 is a component of the spray unit 11, which can be handheld. In this case, the entire pressure washer 1 is portable in operation and can be guided by hand. In particular, the pump unit and the spray unit are then formed integrally. In particular, the pump unit and the spray unit are then arranged in a common housing. In particular, the pump unit and the spray unit are then connected to each other rigidly, in particular not by means of a flexible tube. In particular, the main line 5 is then arranged in a single housing.

The pressure washer 1 comprises a main line valve 8. The main line valve 8 is arranged in the main line 5. The main line valve 8 has two valve states. The two valve states comprise a closed state and an open state. In the open state, the main line valve 8 enables liquid to flow through the main line 5. In the closed state, the main line valve 8 prevents liquid from flowing through the main line 5. In the open state of the main line valve 8, liquid can be sprayed out of the spray opening 6. In the closed state of the main line valve 8, no liquid is sprayed out of the spray opening 6. In the exemplary embodiments, the main line valve 8 is arranged in the spray unit 11. In the exemplary embodiments, the main line valve 8 is arranged between the high-pressure pump 3 and the spray opening 6.

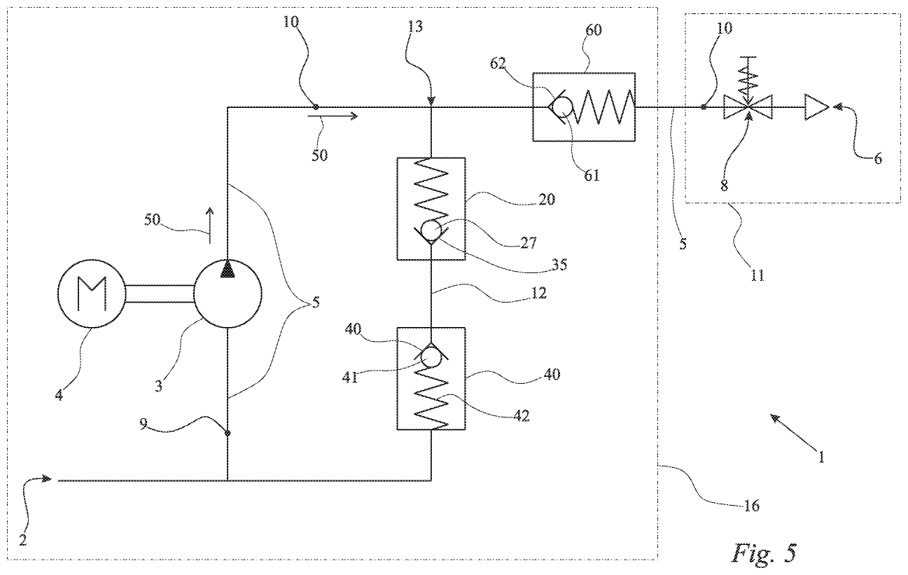

In the exemplary embodiment according to FIGS. 1 to 4, the pressure washer 1 comprises a disconnecting device 7. Such a disconnecting device can also be provided in the exemplary embodiment according to FIG. 5. It can also be provided that, in the exemplary embodiment according to FIGS. 1 to 4, the disconnecting device 7 is forgone. In the exemplary embodiment according to FIGS. 1 to 5, the pressure washer 1 is configured such that the disconnecting device 7 causes, due to the pressure in the pressure chamber 10, the motor 4 to be in the off-state when the pressure in the pressure chamber corresponds at least to a pressure threshold value.

The motor 4 has a switch 18. The switch 18 serves to switch the motor 4 between the on-state and the off-state. The disconnecting device 7 has an actuating element 19. The pressure washer 1 is configured such that the liquid in the pressure chamber 10 acts on the actuating element 19 of the disconnecting device 7 in such a way that the actuating element 19 actuates the switch 18 of the motor 4 in such a way that the motor 4 is in the off-state when the pressure in the pressure chamber 10 corresponds at least to the pressure threshold value.

A pressure relief line 36 is depicted in FIG. 1. The pressure relief line 36 fluidically connects the pressure chamber 10 to the suction chamber 9. By means of the pressure relief line 36, a further fluid connection between the suction chamber 9 and the pressure chamber 10 separate from the fluid connection between the suction chamber 9 and the pressure chamber 10 via the high-pressure pump 3 is possible.

The pressure relief line 36 can be closed or opened. A pressure relief valve 80 is arranged in the pressure relief line 36. The pressure relief valve 80 is configured such that it opens when the pressure in the pressure chamber 10 corresponds at least to the pressure threshold value.

The pressure washer 1 is configured such that there is a fluid connection between the pressure chamber 10 and the suction chamber 9 when the pressure in the pressure chamber 10 corresponds at most to a start pressure value. The start pressure value is less than the pressure threshold value. In the exemplary embodiment, the pressure washer 1 has a return line 12. The return line 12 can fluidically connect the pressure chamber 10 to the suction chamber 9. By means of the return line 12, a further fluid connection between the suction chamber 9 and the pressure chamber 10 separate from the fluid connection between the suction chamber 9 and the pressure chamber 10 via the high-pressure pump 3 and separate from the pressure relief line 36 is possible. In the return line 12, the conveying direction 50 runs from the pressure chamber 10 towards the suction chamber 9.

The pressure washer 1 comprises a start valve 20. The pressure washer 1 is configured such that the start valve 20 closes the start valve 20 when the volume flow through the start valve 20 reaches or exceeds a start volume threshold value. In particular, the pressure in the pressure chamber 10 corresponds at least to the start pressure value when the volume flow through the start valve 20 reaches or exceeds the start volume threshold value. When the start valve 20 is closed, no fluid, in particular no liquid, can flow through the return line 12 from the pressure chamber 10 into the suction chamber 9. In the exemplary embodiment according to FIGS. 1 to 4, the start valve 20 is arranged in the main line 5. In the exemplary embodiment according to FIG. 5, the start valve 20 is arranged in the return line 12. In all exemplary embodiments, the start valve 20 is arranged downstream of the high-pressure pump 3. In the exemplary embodiment according to FIGS. 1 to 4, the start valve 20 is arranged downstream of the high-pressure pump 3 in the main line 5 and/or upstream of the return line 12 in the main line 5. The liquid conveyed by the high-pressure pump 3 first comes into contact with the start valve 20 before it can advance into the return line 12. The start valve 20 is arranged outside the return line 12. In all exemplary embodiments, the start valve 20 is biased toward an open state. The start valve 20 is biased in the direction opposite the conveying direction 50.

The main line 5 is the line of the pressure washer 1 in the region between the high-pressure pump 3 and the spray opening 6 in which the liquid travels the shortest distance from the high-pressure pump 3 to the spray opening 6. Branches off the main line 5, in which liquid may first advance into the branch and then flow back again, are not components of the main line 5.

The pressure washer 1 according to FIGS. 1 to 4 is configured such that, when the pressure washer 1 is in operation, the liquid flows through the start valve 20 with a volume flow below the start volume threshold value without any possibility of branching off from the high-pressure pump 3 to the start valve 20 in the main line 5. In particular, when the pressure washer 1 is in operation, the liquid flows independently of the volume flow through the start valve 20 without any possibility of branching off from the high-pressure pump 3 to the start valve 20 in the main line 5.

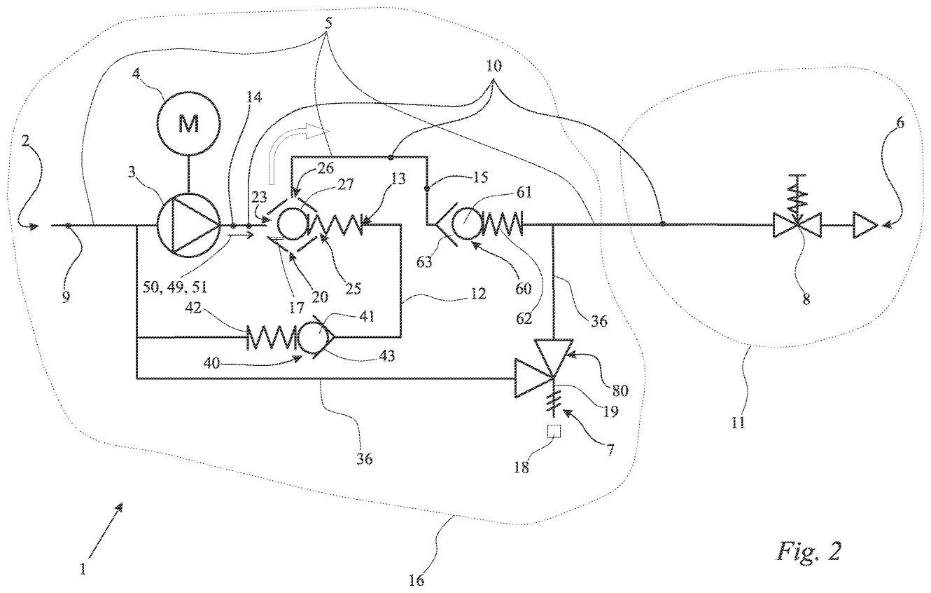

The start valve 20 according to FIGS. 1 to 4 substantially has three states. The states of the start valve 1 are determined by the value of the volume flow through the start valve 20. If the value of the volume flow of the liquid through the start valve 20 is less than an idle volume threshold value, the start valve 20 is in an idle mode. The idle mode of the start valve 20 is depicted in FIGS. 1 and 2. In the idle mode, the pressure exerted on the start valve 20 by the liquid does not suffice to transfer the start valve 20 into another state. The start valve 20 has a valve member 27. The valve member 27 is moveably mounted in a valve housing of the start valve. The valve member 27 is biased toward the idle position of the idle mode. It can be provided that the valve member 27 closes a valve seat of the main line such that liquid is prevented from flowing through the main line 5 by the valve member 27. In the exemplary embodiment, however, the start valve 20 has a stop element 17. In the idle position, the valve member 27 abuts the stop element 17. The valve member 27 is biased in the direction towards the stop element 17. When the volume flow through the start valve 20 is less than the idle volume threshold value, the valve member 27 abuts the stop element 17. In particular, the valve member 27 abuts the stop element 17 when the valve member 27 is in a state unencumbered by the liquid. In the exemplary embodiment according to FIGS. 1 to 4, the start valve 20 is configured in such a way that it is possible for liquid to pass through the start valve 20 in the idle mode. For this purpose, a gap between the valve member 27 and the valve housing is provided when attaching the valve member 27 to the stop element 17.

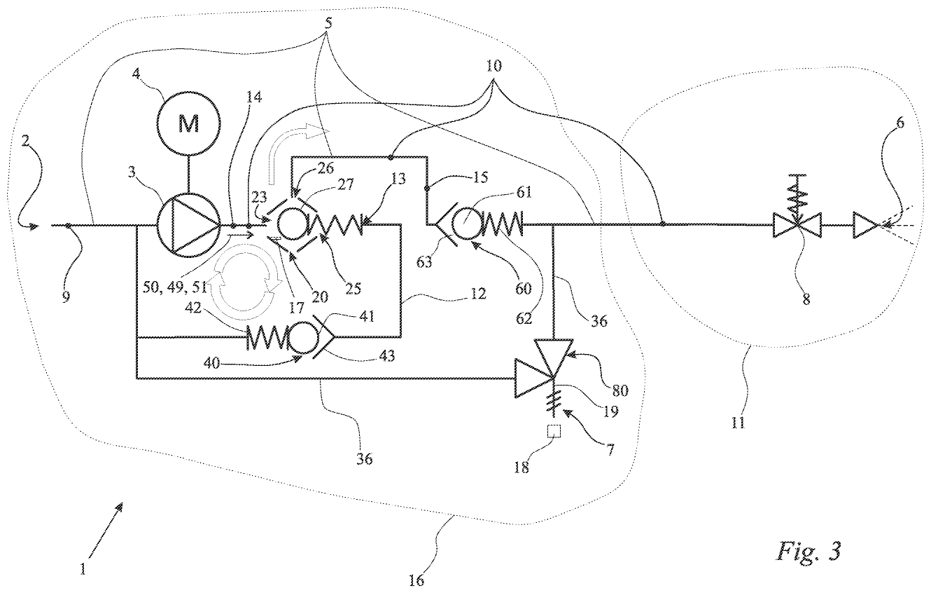

FIG. 3 shows the start valve 20 in a starting mode. In the starting mode, liquid is conveyed through the start valve 20 from the pressure chamber 10 of the main line 5 via the return line 12 back into the suction chamber 9. The value of the volume flow through the start valve 20 corresponds at least to the idle volume threshold value when in the starting mode of the start valve 20. In the starting mode, the value of the volume flow of the liquid through the start valve 20 is smaller than a start volume threshold value. The start volume threshold value is greater than the idle volume threshold value. In the exemplary embodiment, the start valve 20 is configured such that, in the case of a volume flow through the start valve 20 below the start volume threshold value, it allows liquid to pass through from the pressure chamber 10 into the return line 12.

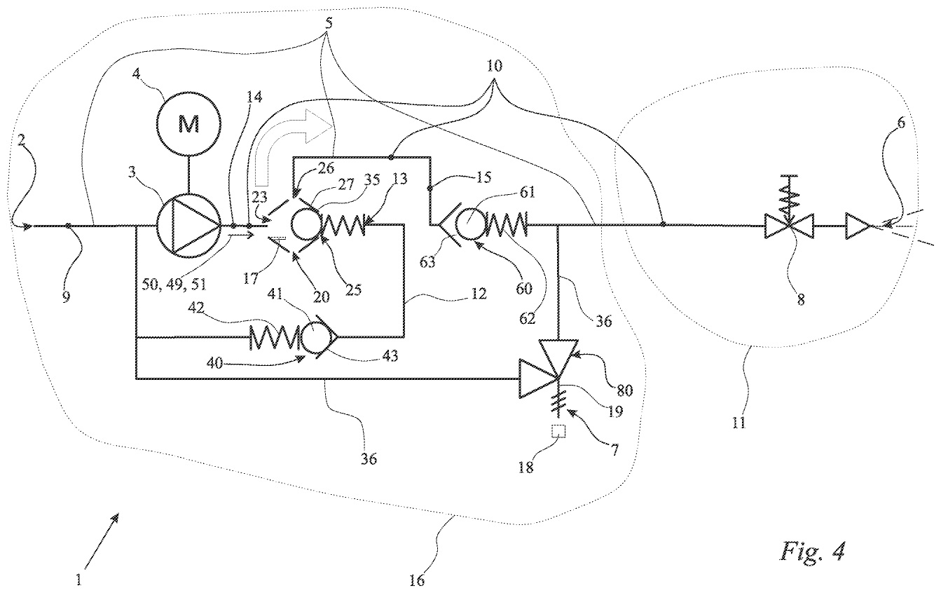

The start valve 20 has a valve seat 35 depicted in FIG. 4. When the valve member 27 abuts the valve seat 35, liquid is prevented from flowing out of the pressure chamber 10 of the main line 5 into the return line 12. In the starting mode, the valve member 27 is in a position in which it abuts neither the stop element 17 nor the valve seat 35.

The start valve 20 divides the pressure chamber 10 of the main line 5 into a pump section 14 and a spray section 15. The pump section 14 of the pressure chamber 10 of the main line 5 extends from the high-pressure pump 2 to the start valve 20. The spray section 15 of the pressure chamber 10 of the main line 5 extends from the start valve 20 to the spray opening 6. In the starting mode of the start valve 20, liquid can flow through the start valve 20 from the pump section 14 into the spray section 15 and from the pump section 14 into the return line 12. The size of the volume flow, which determines the position of the valve member 27 in the start valve 20, is virtually unaffected by the partial branching off of the volume flow into the return line 12, which occurs only after the valve member 27. The size of the volume flow, which determines the position of the valve member 27 in the start valve 20, is virtually unaffected by the partial division of the volume flow, which occurs only after the valve member 27, into a portion of the volume flow that flows into the spray section 15 and a further portion of the volume flow that flows into the return line.

The start valve 20 has an inlet 23. The inlet 23 of the start valve 20 is connected to the main line 5. The inlet 23 of the start valve 20 is connected to the pump section 14 of the pressure chamber 10 of the main line 5. The start valve 20 has a return outlet 25. The return outlet 25 of the start valve 20 is connected to the return line 12. The start valve 20 has a main line outlet 26. The main line outlet 26 is connected to the main line 5. The main line outlet 26 is connected to the spray section 15 of the pressure chamber 10 of the main line 5. The return line 12 has an inlet 13. The valve seat 35 of the start valve 20 is arranged on the inlet 13 of the return line 12. The inlet 13 of the return line 12 coincides with return outlet 25 of the start valve 20.

In the starting mode of the start valve 20, liquid can flow from the inlet 23 of the start valve 20 to the return outlet 25 as well as to the main line outlet 26.

FIG. 4 shows the start valve 20 in a closing mode. In the exemplary embodiment according to FIGS. 1 to 4, the start valve 20 is configured such that in the case of a volume flow through the start valve 20, which corresponds at least to the start volume threshold value, it prevents liquid from flowing from the pressure chamber 10 into the return line 12. When the value of the volume flow through the start valve corresponds at least to the start volume threshold value, the start valve 20 closes the return outlet 25. In the closing mode of the start valve 20, the start valve member 27 abuts the start valve seat 35.

The start valve 20 is configured such that it allows liquid to directly flow from the pump section 14 into the spray section 15 when the value of the volume flow through the start valve 20 corresponds at least to the start volume threshold value. In particular, a lossless flow of liquid from the pump section 14 into the spray section 15 through the start valve 20 is possible in the closing mode. In the closing mode of the start valve 20, the liquid flows directly from the inlet 23 of the start valve 20 to the main line outlet 26 of the start valve 20. In the closing mode of the start valve 20, the liquid conveyed by the high-pressure pump 3 flows directly from the pump section 14 into the spray section 15 without a diversion via the return line 12. The closing mode of the start valve 20 is also referred to as the operating mode.

In the exemplary embodiment according to FIGS. 1 to 4, the start valve member 27 is arranged completely in the main line 5, in particular completely in the pressure chamber 10. The start valve member 27 is in particular arranged completely outside the return line 12. In particular, the start valve seat 35 is formed on an inlet 13 of the return line 12. In particular, the inlet 13 of the return line 12 is formed by the return outlet 25 of the start valve 20.

In all exemplary embodiments, the pressure washer 1 comprises a check valve 60. The check valve 60 serves to prevent a flow of fluid, in particular a flow of liquid, in the direction opposite the conveying direction 50. In a closed state of the check valve 60, the check valve 60 is biased in the direction opposite the conveying direction 50. The check valve 60 is arranged in the pressure chamber 10. The check valve 60 is arranged downstream of the high-pressure pump 3. The check valve 60 is arranged downstream of the return line 12. In the exemplary embodiment according to FIGS. 1 to 4, the check valve 60 is arranged downstream of the start valve 20. In this exemplary embodiment, the check valve 60 is arranged upstream of the disconnecting device 7 in the pressure chamber 10. In the exemplary embodiment according to FIGS. 1 to 4, the start valve 20 is arranged in the main line 5 between the high-pressure pump 3 and the check valve 60. Due to the fact that the disconnecting device 7 is arranged between the check valve 60 and the main line valve 8, the pressure on the disconnecting device 7, as long as the motor 4 for driving the high-pressure pump 3 is running and the main line valve 8 is in the closed state, can only increase and not decrease. This can also have the effect that the pressure on the pressure relief valve 80 can only increase as long as the motor 4 for driving the high-pressure pump 3 is running and the main line valve 8 is in the closed state. In this way, it is ensured that the pressure in the pressure chamber 10 exceeds the pressure threshold value and the disconnecting device 7 transfers the motor 4 into the off-state. It can also be ensured in this way that the pressure in the pressure chamber 10 exceeds the pressure threshold value and the pressure relief valve 80 opens.

In the valve housing of the start valve 20, the start valve member 27 is moveable in a movement direction 49. The liquid conveyed by means of the high-pressure pump 3 from the port 2 to the spray opening 6 through the main line 5 comes into contact with the start valve 20, in particular the start valve member 27 of the start valve 20, in the main line 5 in a flow direction 51. The flow direction 51 is the direction in which the liquid flows through the inlet 23 of the start valve 20 into the start valve 20. The movement direction 49 of the valve member 27 runs in the direction of the flow direction 51. The valve member 27 is moveable to close the valve seat 35 of the start valve 20 in the flow direction 51. Due to a movement of the valve member 27 in the flow direction 51, the valve seat 35 arranged at the inlet 13 of the return line 12 can be closed.

The start valve member 27 is biased in the direction facing away from the inlet 13 of the return line 12. The start valve member 27 is biased opposite the movement direction 49. The stop element 17 restricts a movement of the start valve member 27 in the direction facing away from the return line 12. The stop element 17 limits a movement of the valve member 27 in the direction opposite the flow direction 51. The stop element 17 limits a movement of the start valve member 27 in the direction opposite the movement direction 49.

In all exemplary embodiments, the pressure washer 1 comprises an additional valve 40 formed separately from the start valve 20. The additional valve 40 serves to interrupt the fluid connection between the pressure chamber 10 and the suction chamber 9 made possible by the return line 12. The additional valve 40 is biased toward a closed state in the direction opposite the conveying direction 50. The pressure washer 1 is configured such that the check valve 60 opens at a lower pressure than the additional valve 40. To open the additional valve 40, an additional valve opening pressure is required. To open the check valve 60, a check valve opening pressure is required. The check valve opening pressure is lower than the additional valve opening pressure. In particular, the check valve opening pressure is 50% to 99%, in particular 60% to 95%, in particular 70% to 90% of the additional valve opening pressure.

To open the additional valve 40, an additional valve pressure difference between the pressure in the region that directly abuts the additional valve 40 upstream of the additional valve 40 and the pressure in the range of the return line 12 that directly abuts the additional valve 40 downstream of the additional valve 40 is required in all exemplary embodiments. To open the check valve 60, a check valve pressure difference between the region in the pressure chamber 10 that directly abuts the check valve 60 upstream of the check valve 60 and the region in the pressure chamber 10 that directly abuts the check valve 60 downstream of the check valve 60 is required. The check valve pressure difference is smaller than the additional valve pressure difference. In particular, the check valve pressure difference is 50% to 99%, in particular 60% to 95%, in particular 70% to 90% of the additional valve pressure difference.

To close the start valve 20, a starting pressure difference between the pressure in the region upstream of the start valve 20 and the pressure in the region downstream of the start valve 20, in particular the pressure in the region in the return line 12 downstream of the start valve 20, is required. The additional valve pressure difference is smaller than the start pressure difference. In the start phase of the high-pressure pump 3, in particular of the motor 4, the additional valve 40 opens before the start valve 20 closes.

The check valve 60 is biased with a return restoring force into the closed state of the check valve 60. The additional valve 40 is biased with an additional valve force into the closed state of the additional valve 40. A fluid, in particular the liquid and/or air, can act on the check valve 60 with an, in particular hydraulically effective, return cross-sectional area. A fluid, in particular the liquid and/or air, can act on the additional valve 40 with an, in particular hydraulically effective, additional valve cross-sectional area. In particular, the return restoring force, the return cross-sectional area, the additional valve force and the additional valve cross-sectional area are coordinated with one another in such a way that the check valve 60 opens at a lower pressure, in particular at a lower differential pressure, in particular at a lower opening pressure, than the additional valve 40. In particular, the return restoring force, the return cross-sectional area, the additional valve force and the additional valve cross-sectional area are coordinated with one another in such a way that the check valve pressure difference is smaller than the additional valve pressure difference.

In all exemplary embodiments, the additional valve 40 is arranged in the return line 12. In particular, the additional valve 40 is arranged completely outside the main line 5, in particular the pressure chamber 10.

The additional valve 40 comprises an additional valve member 41 and an additional valve seat 43. The additional valve member 41 is moveable in the additional valve 40. The additional valve seat 43 can be closed by means of the additional valve member 41. In this way, the fluid connection between the pressure chamber 10 and the suction chamber 9 through the return line 12 can be interrupted. In particular, the additional valve 40 substantially prevents air from passing through in the closed state. The additional valve 40 comprises an additional valve spring 42. The additional valve 40 is biased toward the closed state by means of the additional valve spring 42. The additional valve member 41 is biased toward the additional valve seat 43 by means of the additional valve spring 42. The additional valve spring 42 provides the additional valve force.

The additional valve member 41 is arranged in the return line 12, in particular completely outside the main line 5, in particular completely outside the pressure chamber 10.

The additional valve 40 is arranged downstream of the start valve 20 in all exemplary embodiments. However, it can also be provided that the additional valve 40 is arranged upstream of the start valve 20. This applies in the event that the start valve 20 is arranged in the return line 12.

In all exemplary embodiments, the check valve 60 has a check valve member 61 and a check valve seat 63. The check valve member 61 is moveable in the check valve 60. The check valve seat 63 can be closed by means of the check valve member 61. In particular, the check valve 60 substantially prevents air from passing through in the closed state. The check valve 60 comprises a check valve spring 62. The check valve 60 is biased toward the closed state by means of the check valve spring 62. The check valve member 61 is biased toward the check valve seat 63 by means of the check valve spring 62. The check valve spring 62 provides the check valve force.

In the exemplary embodiments, the additional valve force is greater than the check valve force. However, it can also be provided that the additional valve force and the check valve force are equal or that the additional valve force is less than the check valve force.

In the exemplary embodiments, the return cross-sectional area is greater than the additional valve cross-sectional area. However, it can also be provided that the return cross-sectional area and the additional valve cross-sectional area are equal or that the return cross-sectional area is smaller than the additional valve cross-sectional area.

The additional valve member 41 and the start valve member 27 are formed separately from each other. The additional valve member 41 and the start valve member 27 are arranged spatially separated from each other.

In particular after the motor 4 has been switched off by actuating the switch 18 of the disconnecting device 7, depicted in FIGS. 1 to 4, after the main line valve 8 has been closed, there is a high pressure in the pressure chamber 10. This pressure is partially reduced by opening the pressure relief valve 80. Due to this pressure reduction, the start valve 20 opens, such that a return flow of liquid from the pressure chamber 10, in particular from the pump section 14 of the pressure chamber 10 into the suction chamber 9 is possible. The start valve 20 is then either in the idle mode or in the starting mode. When the motor 4 is switched on again, the pump 3 has to work against a much lower pressure due to the opened start valve 20 than it would if the start valve 20 were not present. Due to the arrangement of the start valve 20 in the main line 5, the volume flow which effects a switching of the start valve 20 is clearly defined.

The check valve 60 is opened at a lower pressure than the additional valve 40. If there is still air in the high-pressure pump 3 when the motor 4 is switched on again or when the motor 4 is switched on for the first time after the pressure washer 1 is put into operation, this air can, in all embodiments, be conveyed out of the pressure washer 1 through the main line 5, in particular through the check valve 60, due to the additional valve 40. In particular, the air escapes through the spray opening 6. This situation is depicted by way of example for all exemplary embodiments in FIG. 2. The check valve 60 is opened and the additional valve 40 is closed. The air leaves the pressure washer 1 and is not circulated through the return line 12 due to the additional valve 40.

Subsequently, the high-pressure pump 3 conveys liquid. As is depicted in FIG. 3, the pressure in the return line 12 then suffices to open the additional valve 40. However, the pressure in the pressure chamber 10 does not yet suffice to open the start valve 20. As described, the high-pressure pump 3 can then start without high counterpressure and can reach its operating speed. Only then does the pressure, or the volume flow of the liquid in the pressure chamber 10, suffice to close the start valve 20, as is depicted in FIG. 4. The additional valve 40 then also closes again. The pressure washer 1 has then reached its desired operating state.

The exemplary embodiment according to FIG. 5 only differs from the exemplary embodiment according to FIGS. 1 to 4 in that no pressure relief line 36 is provided and in that the start valve 20 is arranged outside the main line 5, in particular the pressure chamber 10. Otherwise, the description of the exemplary embodiment according to FIGS. 1 to 4 also applies to the exemplary embodiment according to FIG. 5.

What is claimed is:

1. A pressure washer, comprising:
a high-pressure pump (3) configured to convey a liquid in a conveying direction (50); and
a main line (5) through which the liquid is conveyed by the high-pressure pump (3), the main line (5) including
a suction chamber (9) arranged upstream of the high-pressure pump (3),
a pressure chamber (10) arranged downstream of the high-pressure pump (3), and
a return line (12) fluidically connecting the pressure chamber (10) and the suction chamber (9);
a start valve (20) configured to prevent flow of the liquid through the return line (12), the start valve (20) being biased toward an open state in a direction opposite the conveying direction (50);
a check valve (60) configured to prevent flow of the liquid opposite the conveying direction (50), the check valve (60) being biased toward a closed state in a direction opposite the conveying direction (50) and arranged in the pressure chamber (10) downstream of the return line (12);
an additional valve (40) separate from the start valve (20) and configured to interrupt a fluid connection between the pressure chamber (10) and the suction chamber (9) via the return line (12), the additional valve (40) being biased toward a closed state opposite the conveying direction (50),
wherein the check valve (60) is configured to open at a lower pressure than the additional valve (40).

2. The pressure washer of claim 1,
wherein the check valve (60) is biased toward the closed state of the check valve (60) with a return restoring force,
wherein the additional valve (40) is biased toward the closed state of the additional valve (40) with an additional valve force,
wherein a fluid can act on the check valve (60) with a return cross-sectional area,
wherein a fluid can act on the additional valve (40) with an additional valve cross-sectional area, and
wherein the return restoring force, the return cross-sectional area, the additional valve force, and the additional valve cross-sectional area are coordinated with one another such that the check valve (60) opens at a lower pressure than the additional valve (40).

3. The pressure washer of claim 2,
wherein the check valve (60) includes a check valve spring (62) configured to provide the return restoring force, and/or
wherein the additional valve (40) includes an additional valve spring (42) configured to provide the additional valve force.

4. The pressure washer of claim 1,
wherein the start valve (20) includes a start valve member (27), and
wherein the start valve member (27) is separate from an additional valve member (41) of the additional valve (40).

5. The pressure washer of claim 1,
wherein the start valve (20) is arranged in the main line (5) downstream of the high-pressure pump (3).

6. The pressure washer of claim 4,
wherein the start valve member (27) is arranged completely within the main line

(5) .

7. The pressure washer of claim 4,
wherein the start valve member (27) is arranged completely outside the return line (12).

8. The pressure washer of claim 1,
wherein a start valve seat (35) of the start valve (20) is formed at an inlet (13) of the return line (12).

9. The pressure washer of claim 1,
wherein the additional valve (40) is arranged in the return line (12).

10. The pressure washer of claim 1,
wherein the additional valve (40) is arranged downstream of the start valve (20).

11. The pressure washer of claim 1,
wherein a start pressure difference between a region upstream of the start valve (20) and a region downstream of the start valve (20) is required to close the start valve,
wherein an additional valve pressure difference between a region upstream of the additional valve (40) and a region downstream of the additional valve (40) is required to open the additional valve (40), and
wherein the additional valve pressure difference is less than the start pressure difference.

12. A method for operating a pressure washer, the pressure washer (1) comprising
a high-pressure pump (3) configured to convey a liquid in a conveying direction (50) ; and
a main line (5) through which the liquid is conveyed by the high-pressure pump (3), the main line (5) including
a suction chamber (9) arranged upstream of the high-pressure pump (3),
a pressure chamber (10) arranged downstream of the high-pressure pump (3), and
a return line (12) fluidically connecting the pressure chamber (10) and the suction chamber (9);
a start valve (20) configured to prevent flow of the liquid through the return line (12), the start valve (20) being biased toward an open state in a direction opposite the conveying direction (50);
a check valve (60) configured to prevent flow of the liquid opposite the conveying direction (50), the check valve (60) being biased toward a closed state in a direction opposite the conveying direction (50) and arranged in the pressure chamber (10) downstream of the return line (12);
an additional valve (40) separate from the start valve (20) and configured to interrupt a fluid connection between the pressure chamber (10) and the suction chamber (9) via the return line (12), the additional valve (40) being biased toward a closed state opposite the conveying direction (50),
the method comprising:
operating the high-pressure pump to convey the liquid in the conveying direction;
allowing the check valve to open when a pressure in the pressure chamber exceeds a first threshold pressure; and
maintaining the additional valve closed until the pressure exceeds a second threshold pressure higher than the first threshold pressure.
